(19) United States
(12) Patent Application Publication
(10) Pub. No.: US 2004/0178382 A1
(43) Pub. Date: Sep. 16, 2004

(54) Ball valve

(76) Inventor: Jong Chan Yun, Busan (KR)

Correspondence Address: BIRCH STEWART KOLASCH & BIRCH, PO BOX 747, FALLS CHURCH, VA, 22040-0747, US

(21) Appl. No.: 10/730,086

(22) Filed: Dec. 9, 2003

(30) Foreign Application Priority Data
Mar. 10, 2003 (KR) 10-2003-0014879

(51) Int. Cl. F16K 5/06

(52) U.S. Cl. 251/315.12

(57) ABSTRACT

A ball valve comprises a main body having a chamber, inlet and outlet pipes and an extension tube, the chamber having a hollow interior, the extension tube being connected to the hollow interior of the chamber and the inlet and outlet pipes being connected to the hollow interior of the chamber, a switching member having a ball and a rotary shaft, the ball having a channel formed therein correspondingly to the inlet and outlet pipes and the rotary shaft being connected to the ball, and a sealing member having a channel securing hole corresponding to the channel of the ball, the sealing member being formed of elastic material in a cylindrical shape for containing the ball therein.

### BACKGROUND OF THE INVENTION

1. Field of the Invention

The present invention relates to a valve and more particularly, to a ball valve for regulating or shutting off the flow of fluid.

2. Discussion of the Related Art

In general, a valve is used to allow or shut off the flow of fluid in the pipe system. There exists many different types of valves to regulate the flow of fluid and a ball valve may be selected as one of the valve for the object depending on the situation.

FIG. 1 is an exploded view of a prior art ball valve. In FIG. 1, the prior art ball valve 1000 mainly consists of a main body 500, a sealing member 600, a channel securing ring 630 and a switching member 700. The main body 500 has a chamber 510, an extension tube 520, an inlet pipe 530 and an outlet pipe 540. The chamber 510 has a hollow interior and the extension tube 520 is connected to the hollow interior of the chamber 510. The inlet pipe 530 is formed at one end of the chamber 510 and the outlet pipe 540 is formed at the other end of the chamber 510. The inlet and outlet pipes 530 and 540 are connected to the hollow interior of the chamber 510. The sealing member 600 consists of the channel securing ring 630 and upper and lower sealing covers 610 and 620. The upper sealing cover 610 has a cylindrical shape whose bottom side is open and has an upper hole 612 into which a rotary shaft 720 of the switching member 700 is inserted. The lower sealing cover 620 has a symmetric shape with the upper sealing cover 610 and has a lower hole 622 at the bottom into which the rotary shaft 720 is inserted. The upper and lower sealing covers 610 and 620 has four upper and lower semicircular holes 614 and 624 formed in a circumferential direction to hold the channel securing rings 630.

FIG. 2 is a front view illustrating a switching member 700 and a sealing member 600 of FIG. 1. As shown in FIG. 2, the upper and lower semicircular holes 614 and the 624 form a circular channel securing hole 634 when the upper sealing cover 610 is assembled to the lower sealing cover 620. The channel securing ring 630 is inserted into the channel securing hole 634. The channel securing ring 630 helps the channel securing hole 634 to keep a circular shape and the channel securing hole 634 has a same diameter as that of a channel 712 formed in a ball 710 of FIG. 1.

FIG. 3 is a front view of an assembled upper and lower sealing covers 610 and 620 without the channel securing ring 630 to explain a function and an usefulness of a channel securing ring 630 of FIG. 1. As shown in FIG. 3, if there is no channel securing ring 630 between the upper and lower sealing covers 610 and 620, the channel securing hole 634 fails to keep its circular shape. The switching member 700 has the ball 710 having the channel 712 formed therein to allow the flow of fluid and the rotary shaft 720 connected to the ball 710.

The prior art ball valve 1000 can be assembled by mounting the switching member 700 on the lower sealing cover 620, inserting the channel securing ring 630 onto the lower semicircular hole 624 and then inserting the rotary shaft 720 into the upper sealing cover 610. The assembled switching member 700 and the sealing member 600 is subsequently put into the hollow interior of the chamber 510. If the channel 712 of the ball 710 is set to a position corresponding to the inlet and outlet pipes 530 and 540 by rotating the rotary shaft 720, the ball valve allows fluid to flow from the inlet pipe 530 to the outlet pipe 540. To shut off the flow of fluid, the rotary shaft 720 should be rotated 90° (degree) such that the channel 712 does not correspond to the inlet and outlet pipes 530 and 540.

However, the aforementioned prior art ball valve 1000 has some drawbacks as follows. That is, the prior art ball valve 1000 necessarily requires the channel securing ring 630 to keep the channel securing hole 634 in a circular shape. Accordingly, the number of the parts becomes increased and it takes much time to assemble the ball valve owing to a small size of the channel securing ring 630.

### SUMMARY OF THE INVENTION

Accordingly, the present invention is directed to an improved ball valve that substantially obviates one or more of problems due to limitations and disadvantages of the related art.

An object of the present invention is to provide an improved ball valve in which a cylindrical sealing member is integrally formed of elastic material to reduce the number of parts of the ball valve and increase an efficiency of the assembly process.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a ball valve comprises a main body having a chamber, inlet and outlet pipes and an extension tube, the chamber having a hollow interior, the extension tube being connected to the hollow interior of the chamber and the inlet and outlet pipes being connected to the hollow interior of the chamber, a switching member having a ball and a rotary shaft, the ball having a channel formed therein correspondingly to the inlet and outlet pipes and the rotary shaft being connected to the ball and a sealing member having a channel securing hole corresponding to the channel of the ball, the sealing member being formed of elastic material in a cylindrical shape for containing the ball therein.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is an exploded view of a prior art ball valve;

FIG. 2 is a front view illustrating a switching member and a sealing member of FIG. 1;

FIG. 3 is a front view of an assembled upper and lower sealing covers of FIG. 1 without an channel securing ring to explain a function and a usefulness of a channel securing ring of FIG. 1;

FIG. 4 is an exploded view of the present invention;

FIG. 5 is a perspective view of a switching member and a sealing member of the present invention;

FIG. 6 and FIG. 7 are cross-sectional views of the switching member and the sealing member to show the way the switching member is installed into the sealing member according to the present invention; and

FIG. 8 and FIG. 9 are cross-sectional views illustrating a state of a ball valve in use according to the present invention for regulating or shutting off the flow of fluid

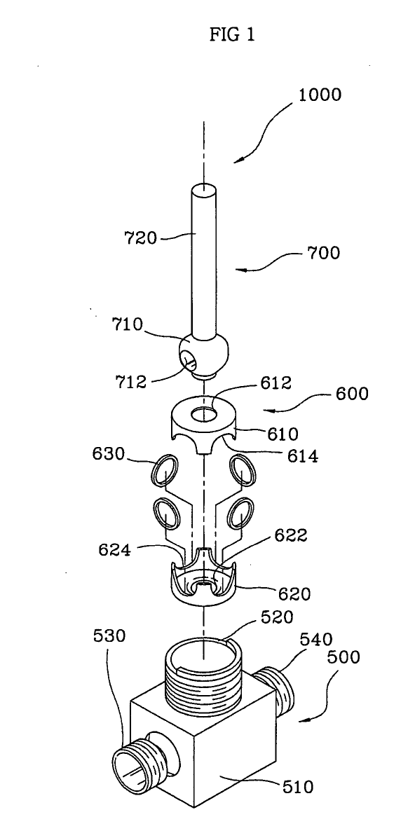

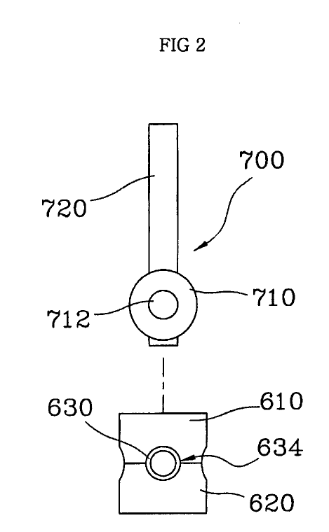

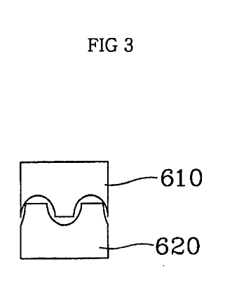

### DETAILED DESCRIPTION OF THE ILLUSTRATED EMBODIMENTS

Reference will now be made in detail to the illustrated embodiment of the present invention, which is illustrated in the accompanying drawings.

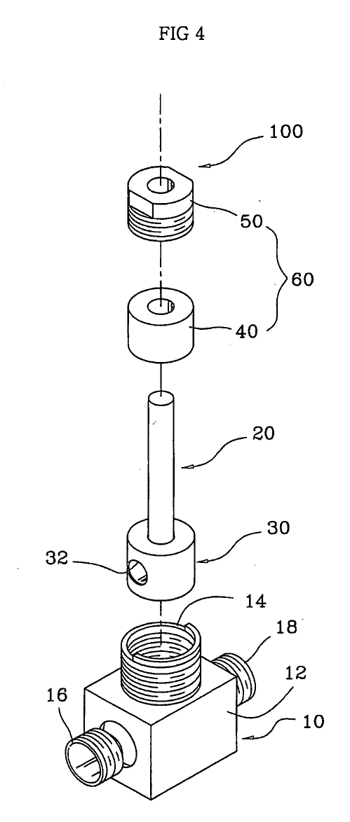

The preferred embodiment of the present invention will be described hereinafter with reference to the drawings attached. FIG. 4 is an exploded view of the present invention. In FIG. 4, a ball valve 100 according to the present invention has a main body 10, a switching member 20, a sealing member 30 and a leak stopper 60. The main body 10 has a chamber 12, an extension tube 14, an inlet pipe 16 and an outlet pipe 18. The chamber 12 has a hollow interior formed therein and the extension tube 14 is connected to the hollow interior of the chamber 12. The inlet and outlet pipes 16 and 18 are connected to the hollow interior of the chamber 12. Fluid can flow from the inlet pipe 16 to the outlet pipe 18 by controlling the switching member 20. According to one embodiment of the present invention, the chamber 12 has a shape of a hexahedron and the inlet pipe 16 is parallel to the outlet pipe 18. However, the shape of the chamber 12 and an angle between the inlet pipe 16 and the outlet pipe 18 can be modified diversely depending on the situation. Screw threads may further be formed in an interior side of the main body 10. The switching member 20 has a ball 22 that will be disposed in the hollow interior of the chamber 12 and a rotary shaft 24. The ball 22 is provided with a channel 26 formed therein in a direction according to the inlet pipe 16 and the outlet pipe 18 to allow or shut off the flow of fluid. In FIG. 4, because the inlet pipe 16 is parallel to the outlet pipe 18, the channel 26 is formed in a parallel direction to the inlet and outlet pipes 16 and 18. On the other hand, if the inlet pipe 16 is perpendicular to the outlet pipe 18, the ball 22 will be provided with L-shaped channel. Furthermore, if the chamber 12 has a plurality of inlet and outlet pipes 16 and 18 connected thereto, the ball 22 should have a plurality of channels corresponding to the inlet and outlet pipes 16 and 18.

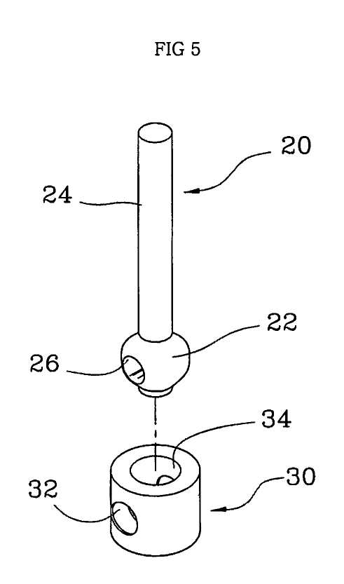

FIG. 5 is a perspective view of a switching member 20 and a sealing member 30 of the present invention. In FIG. 5, the switching member 20 has the ball 22 and a rotary shaft 24 connected thereto. The sealing member 30 is formed of elastic material such as a rubber, for example, in a shape of hollow cylinder. The ball 22 is to be disposed in the hollow interior of the sealing member 30 in a later assembly process. The sealing member 30 is provided with a channel securing hole 32 corresponding to the channel 26 of the ball 22 and serves to prevent fluid from leaking out of the extension tube 14. That is, the sealing member 30 is put into the hollow cylindrical interior of the chamber 12 without a clearance between the interior surface of the chamber 12 and the outer surface of the sealing member 30 to prevent the leakage of fluid.

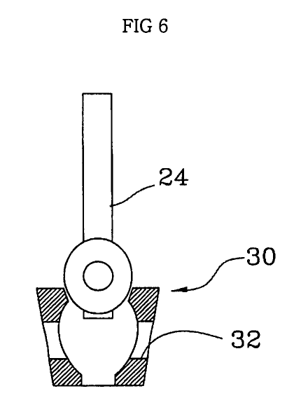

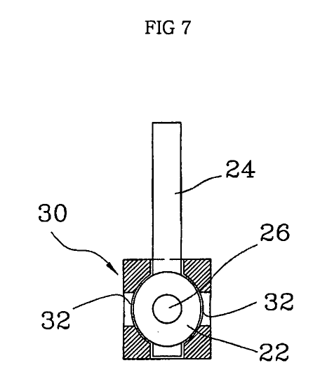

FIG. 6 and FIG. 7 are cross-sectional views of the switching member 20 and the sealing member 30 to show the way the switching member 20 is installed into the sealing member 30 according to the present invention. In FIG. 6, the ball 22 can be put into the integrally formed sealing member 30 using a deformable characteristic of the sealing member 30. That is, an entrance portion 34 in FIG. 5 can be widened to allow the ball 22 to move into the sealing member 30 because the sealing member 30 is formed of elastic material as stated above. The ball 22 is assembled to the sealing member 30 in a way that a direction of the channel 26 coincides with a direction of the channel securing hole 32. FIG. 7 shows an assembly of the switching member 20 and the sealing member 30.

The leak stopper 60 of FIG. 4 having a sleeve 40 of FIG. 5 and a fastener 50 of FIG. 5 serves to prevent a leakage of fluid out of the extension tube 14 more securely. The sleeve 40 and the fastener 50 can be assembled to the rotary shaft 24 by inserting the rotary shaft 24 to holes formed respectively at centers of the sleeve 40 and the fastener 50. The fastener 50 has screw threads formed on its outer surface so that the fastener 50 can be tightly joined with the extension tube 14 having screw threads formed on its inner surface.

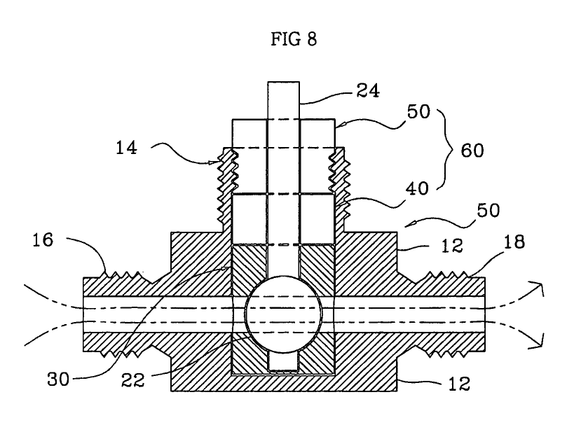

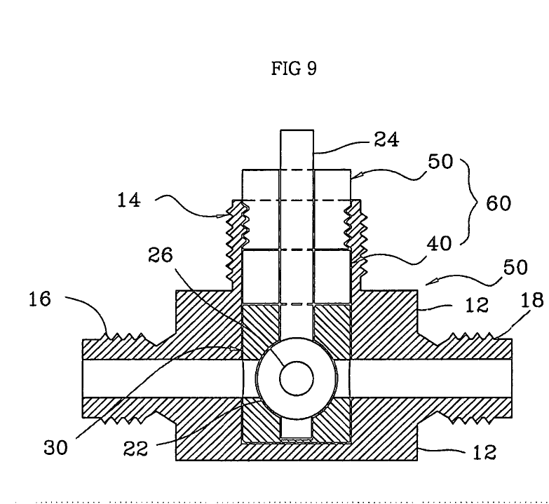

FIG. 8 and FIG. 9 are cross-sectional views illustrating a state of a ball valve in use according to the present invention for regulating or shutting off the flow of fluid. An operation principle of the ball valve 100 according to the present invention will be described hereinafter with reference to FIG. 8 and FIG. 9. After the ball valve 100 is assembled, the inlet pipe 16 is connected to a first pipe (not shown) supplying fluid to the ball valve 100 and the outlet pipe 18 is connected to a second pipe (not shown) receiving the fluid supplied from the first pipe. When it needs to flow the fluid from the first pipe to the second pipe, the channel 26 is set to a position parallel to the inlet and outlet pipes 16 and 18 by rotating the rotary shaft 24 as shown in FIG. 8. On the other hand, setting the channel 26 to a position perpendicular to the inlet and outlet pipes 16 and 18 by rotating the rotary shaft 24 can shut off the flow of fluid as shown in FIG. 9. Because the sealing member 30 and the leak stopper 60 tightly seal the extension tube 14, the fluid cannot leak out of the extension tube 14.

As stated above, the sealing member of the present invention can be integrally manufactured as a single body so that the number of parts consisting of the ball valve and a manufacturing cost can be reduced. In addition, time required for assembling the ball valve can be minimized according to the present invention.

It will be apparent to those skilled in the art that various modifications and variations can be made in the fabrication and application of the present invention without departing from the spirit or scope of the invention. Thus, it is intended that the present invention cover the modifications and variations of this invention provided they come within the scope of the appended claims and their equivalents.

What is claimed is:

1. A ball valve, comprising:
a main body having a chamber, inlet and outlet pipes and an extension tube, the chamber having a hollow interior, the extension tube being connected to the hollow interior of the chamber and the inlet and outlet pipes being connected to the hollow interior of the chamber;
a switching member having a ball and a rotary shaft, the ball having a channel formed therein correspondingly to the inlet and outlet pipes and the rotary shaft being connected to the ball; and
a sealing member having a channel securing hole corresponding to the channel of the ball, the sealing member being formed of elastic material in a cylindrical shape for containing the ball therein.

2. The ball valve according to claim 1, wherein the sealing member is integrally formed as a single body and the ball can be inserted into the sealing member using an elastic deformation of the sealing member.

3. The ball valve according to claim 1, further comprising a leak stopper having a sleeve and a fastener, wherein the rotary shaft is inserted into a center hole of the leak stopper and the fastener provided with a mail screw is jointed with the extension tube provided with a female screw.

4. The ball valve according to claim 1, wherein the inlet pipe is parallel with the outlet pipe and the channel is formed correspondingly to the inlet pipe and the outlet pipe.

5. The ball valve according to claim 1, wherein the inlet pipe is perpendicular to the outlet pipe and the channel is formed correspondingly to the inlet pipe and the outlet pipe.

6. The ball valve according to claim 1, wherein the main body has a plurality of inlet and outlet pipes and the channel is formed correspondingly to the inlet and outlet pipes.
